(19) United States
(12) Patent Application Publication
(10) Pub. No.: US 2023/0396106 A1
(43) Pub. Date: Dec. 7, 2023

(54) ROTOR FOR AN ELECTRIC MOTOR, METHOD OF PRODUCING THE ROTOR, DEVICE FOR PRODUCING THE ROTOR, AND ELECTRIC MOTOR

(71) Applicant: Brose Fahrzeugteile SE & Co. Kommanditgesellschaft, Würzburg, Würzburg (DE)

(72) Inventors: Jochen Dehn, Veitshöchheim (DE); Sandro Fischer, Hardheim (DE)

(21) Appl. No.: 18/452,837

(22) Filed: Aug. 21, 2023

Related U.S. Application Data
(63) Continuation of application No. PCT/EP2022/063528, filed on May 19, 2022.

(30) Foreign Application Priority Data
May 20, 2021 (DE) 10 2021 205 178.2
Aug. 26, 2021 (DE) 10 2021 209 396.5

(51) Int. Cl. H02K 1/278; H02K 15/03; H02K 1/28

(52) U.S. Cl. CPC H02K 1/278; H02K 15/03; H02K 1/28

(57) ABSTRACT

A rotor for an electric motor has a rotor body with a cylindrical rotor core and a number of surface magnets, which are distributed on a lateral surface of the rotor core in the form of rotor poles and which have a bread loaf-shaped cross-section with a convex curvature oriented towards the outer circumference. The rotor further has a sleeve-shaped protective cover, which is exposed on the outer circumference of the rotor body. The protective cover has a flange collar at least on an end face. The flange collar is shaped into radially indented regions between the curvatures of tangentially adjacent surface magnets resulting in a form-locking and/or a force locking connection between the radially indented regions and the surface magnets.

### CROSS-REFERENCE TO RELATED APPLICATION

This application is a continuation, under 35 U.S.C. § 120, of copending International Patent Application PCT/EP2022/063528, filed May 19, 2022, which designated the United States; this application also claims the priority, under 35 U.S.C. § 119, of German Patent Applications DE 10 2021 205 178.2, filed May 20, 2021, DE 10 2021 209 396.5, filed Aug. 26, 2021; the prior applications are herewith incorporated by reference in their entirety.

### FIELD AND BACKGROUND OF THE INVENTION

The invention relates to a rotor for an electric motor having a rotor body with a cylindrical rotor core and with a number of surface magnets and a sleeve-like protective cover which is positioned on the outer circumference of the rotor body. The invention further relates to a method and a device for producing such a rotor and an electric motor having such a rotor.

In a modern motor vehicle, electric motors are used in many different ways as drives for different adjusting elements. Electric motors are used, for example, as window lifter drives, sliding roof drives or seat adjuster drives, as steering drives (EPS, Electrical Power Steering) as cooling fan drives or as gear actuators. Such electric motors have to have a relatively high torque density or power density and to be operationally reliable even at high temperatures.

An electric motor, as an energy converter of electrical energy into mechanical energy, contains a stator which forms the stationary motor part and a rotor which forms the moving motor part. In the case of an internal rotor motor, the stator is generally provided with a stator yoke on which stator teeth are arranged radially to the center, i.e. protruding inwardly in a star-shaped manner, the free ends thereof facing the rotor forming the so-called pole shoe.

In particular, a brushless electric motor as an electrical (three phase) machine generally has a stator which is provided with a field winding or stator winding and which is arranged coaxially to a rotor with one or more permanent magnets.

The rotor generally has a rotor body with a cylindrical punched-packed (rotor) laminated core as the central rotor core. The rotor core is joined to a motor shaft of the electric motor, for example fixedly to the shaft. The rotor core has, for example, receivers into which the permanent magnets are pressed. Alternatively, for example, it is also conceivable that the permanent magnets are fastened or held as surface magnets on an outer circumference of a lateral surface of the rotor core. To this end, it is conceivable, for example, that the surface magnets are joined to the lateral surface by a material connection, in particular by means of an adhesive or epoxy. Holding devices for fastening and/or holding the surface magnets on the lateral surface without a material connection are also conceivable.

The surface magnets in this case conventionally have a bread loaf-shaped cross-sectional shape. In other words, the permanent magnets of the rotor are designed as surface-mounted bread loaf-shaped magnets. A bread loaf-shaped cross-sectional shape, in particular, is to be understood to mean here and hereinafter the shape of a box-shaped bread loaf with a rectangular shape in which one of the longitudinal sides is configured to be curved outwardly in a convex manner. Due to the curvatures of the surface magnets, the outer circumference of the rotor body does not have a circular shape.

During the operation of the electric motor, large centrifugal forces act on the surface magnets of the rotor as a result of the high rotational speeds, whereby the risk increases of the surface magnets being undesirably released from the lateral surface. In order to prevent that a surface magnet is released from the lateral surface and blocks the electric motor in a gap region between the rotor and the stator, generally a sleeve-like protective cover (protective tube) is positioned on the rotor body as an anti-slip device.

Typically, an edge of the protective cover for fastening to the rotor body is bent radially inwardly (crimped) over the circumference, so that the rotor body is axially encompassed by the protective cover on the end face. The shaping or crimping takes place here, for example, by means of roller burnishing or by pressing.

During the roller burnishing or rolling, the material of the protective cover is deformed over the circumference. Since the protective cover to be deformed is not held all around by the rotor core due to the curvatures of the surface magnets, it results in the material of the protective cover being partially constricted during the roller burnishing, whereby it can lead to a formation of cracks and a reduction in the mechanical stability of the protective cover associated therewith.

During the pressing, a round tool is pressed from above on the end face against the protective cover or the rotor body. Relatively large forces are required, so that the resulting mechanical (compressive) stresses lead to bulking, i.e. compression, curving or cambering, of the protective cover, whereby the material of the protective cover migrates radially into the air gap between the rotor and the stator.

A protective cover for a rotor, which has a flange collar which is crimped for fastening to the rotor body on the end face, is disclosed in published, non-prosecuted German patent application DE 10 2019 205 993 A1. The flange collar has a plurality of recesses running tangentially and axially, the stresses occurring during the crimping being reduced thereby.

### SUMMARY OF THE INVENTION

The object of the invention is to specify a particularly suitable rotor for an electric motor and a corresponding electric motor. The object of the invention is also to specify a particularly suitable method and a particularly suitable device for producing such a rotor. In particular, a cost-effective assembly of the rotor with less effort and in which the required assembly forces are reduced is intended to be made possible.

Regarding the rotor, the object is achieved by the features of the independent rotor claim and regarding the method by the features of the independent method claim and regarding the device by the features of the independent device claim and regarding the electric motor by the features of the independent electric motor claim according to the invention. Advantageous embodiments and developments form the subject matter of the dependent claims.

The rotor according to the invention is suitable and configured for an electric motor, in particular for an internal rotor configured as a surface permanent magnet (SPM) motor of a motor vehicle. In other words, the rotor according to the invention is configured, in particular, as an SPM rotor.

The rotor has a rotor body which can be joined or is joined to a motor shaft, fixedly to the shaft. The rotor body has a cylindrical rotor core which is configured, for example, as a punch-packed laminated core (laminated rotor core) with a number of rotor laminations stacked in an axial direction. A number of permanently magnetic surface magnets are arranged so as to be distributed as rotor magnets or pole magnets on the outer circumference of a lateral surface of the rotor core. The surface magnets have a bread loaf-shaped cross-sectional shape with a convex curvature oriented toward the outer circumference. The rotor core has, in particular, an equal-sided polygonal or multi-cornered bottom surface so that the lateral surface has in a tangential or azimuthal direction, i.e. along the outer circumference, a number of bearing surfaces with the same surface area for the surface magnets.

For protecting the surface magnets against slipping, a sleeve-like protective cover is positioned on the outer circumference of the rotor body. According to the invention, the protective cover has a flange collar at least on an end face, the flange collar being shaped into the radially indented regions or flanks between the curvatures of tangentially adjacent surface magnets in a positive and/or non-positive manner. As a result, a particularly suitable rotor is produced.

According to the invention, therefore, the space between the surface magnets is used for fastening the protective cover to the rotor body. Since in these regions the spacing between the rotor body and a surrounding stator is greater than in the region of the curvatures (or the crests thereof), a bulky (compressed, curved, cambered) material of the protective cover, due to the shaping, does not negatively affect the air gap or the electric motor.

In contrast to the prior art, the crimped edge or flange collar on the end face of the protective cover is thus not shaped over the entire circumference but only at the points arranged between the curvatures. According to the invention, therefore, the non-circular external circumferential shape of the rotor body is used for fastening the protective cover.

The conjunction “and/or” is to be understood to mean here and hereinafter such that the features linked by this conjunction can be configured together and as alternatives to one another.

A “positive fit”, a “positive connection” or a “form-locking connection” between at least two parts connected together is understood here and hereinafter, in particular, to mean that the parts connected together are held together at least in one direction by a direct interlocking of the contours of the parts themselves or by an indirect interlocking via an additional connecting part. The “blocking” of a mutual movement in this direction is thus dictated by the shape.

A “non-positive fit”, a “non-positive connection” or a “force-locking connection” between at least two parts connected together is understood here and hereinafter to mean, in particular, that the parts connected together are prevented from sliding off one another due to a frictional force acting therebetween. If a “connecting force” producing this frictional force is absent (i.e. the force which pushes the parts together, for example a screw force or the weight force itself) the non-positive connection cannot be maintained and thus can be released.

“Axial” or an “axial direction” is understood to mean here and hereinafter, in particular, a direction parallel (coaxial) to the axis of rotation of the electric motor, i.e. perpendicular to the end faces of the rotor. Accordingly “radial” or a “radial direction”, is understood to mean here and hereinafter, in particular, a direction oriented perpendicularly (transversely) to the axis of rotation of the electric motor along a radius of the rotor or the electric motor. “Tangential” or a “tangential direction” is understood to mean here and hereinafter, in particular, a direction along the circumference of the rotor (circumferential direction, azimuthal direction), i.e. a direction perpendicular to the axial direction and to the radial direction.

In an advantageous embodiment, the rotor body has a holding device positioned on the rotor core on the end face for fastening and/or holding the surface magnets on the lateral surface of the rotor core without a material connection. The curvatures of the surface magnets radially protrude over the outer circumference of the holding device. In other words, the curvatures of the surface magnets form the radially outermost points of the rotor body. Since the holding device is slightly smaller and also that no magnet is located in the axial direction in the regions between the curvatures, during the shaping process the material of the protective cover can also be forced downwardly, i.e. axially away from the shaped end face, into the free region, which leads to a reduced bulk of material in the radial direction. As a result, the protective cover nestles against the rotor body in a particularly compact manner in terms of installation space so that in the installed state an air gap which is as uniform as possible is produced between the rotor and the stator.

A “material fit” or a “material connection” between at least two parts connected together is understood to mean here and hereinafter, in particular, that the parts which are connected together are held together on their contact surfaces by a material association or cross linking (for example due to atomic or molecular bonding forces), optionally by the action of an additive. Accordingly, “without a material connection” means, in particular, that when the surface magnets are fastened no material connection is present between the surface magnets and the lateral surface. The surface magnets are thus fastened by means of the holding device to the rotor core merely in a positive and/or non-positive manner.

The holding device has, for example, two one-piece, i.e. integral or monolithic, holding rings (insulation disks) which are arranged on the opposing end faces of the rotor core. The holding rings, which are designed for example as injection-molded parts, have in each case a circular ring-shaped annular body with radially external holding contours projecting axially in the direction of the rotor core.

The holding rings are produced, in particular, from a glass fiber-reinforced plastics material, for example from a polyamide (PA), in particular PA 6.6 GF30, or from a polyphenylene sulfide (PPS), in particular PPS GF30, or a polyoxymethylene (POM), in particular POM GF30. The abbreviation GF30 stands in this case for a glass fiber content of 30%.

The holding contours are configured such that they engage radially and tangentially positively between the surface magnets. As a result, the surface magnets are held on the lateral surface in the radial and tangential direction without a material connection. For the axial fixing of the surface magnets, for example, it is provided that the surface magnets are gripped axially between the two holding rings. To this end, the surface magnets are radially covered at least in some portions by the annular body. In particular, therefore, an axial positive connection is implemented between the holding rings.

Thus, the geometry required for holding and/or fastening the surface magnets is only provided on the holding device, whereby the rotor core can have a particularly simple geometric shape. In particular, the rotor core has no additional receivers or contours or projections on the lateral surface, whereby the rotor laminations and thus the rotor core can be produced particularly simply and cost-effectively. Moreover, due to the arrangement of the permanent magnets on the lateral surface, the magnetic field lines of the permanent magnets inside the rotor core are not disturbed.

The method according to the invention is provided and is suitable and configured for producing an above-described rotor. The embodiments in connection with the rotor also expediently apply to the method and vice versa.

If the method steps are described hereinafter, this results in advantageous embodiments for the device, in particular by this device being configured to carry out one or more of these method steps.

According to the method, a rotor body and a protective cover are provided. The sleeve-like protective cover, for example, is designed to be substantially pot-shaped, for example. This means that the protective cover has a (cover) base as a bearing surface on the end face for the rotor body. The base or the bearing surface has, for example, a central recess as a through-opening for a motor shaft. A region of the protective cover on the end face opposing the bearing surface is designed as a flange collar of the protective cover and, after the rotor body has been inserted into the protective cover, is shaped, press-fitted or crimped into the radially indented regions between the curvatures of the tangentially adjacent surface magnets in a positive and/or non-positive manner. This means that the assembly forces for joining the protective cover to the rotor body are incorporated in a targeted manner in the intermediate regions between the curvatures. As a result, in particular in the region of the holding device, the required assembly forces are reduced and there is substantially no radially protruding deformation of the protective cover into the air gap region, whereby the system reliability is improved in the case of an electric motor. The method can be substantially used in all SPM rotors with bread loaf-shaped magnets, irrespective of the number of poles.

In contrast to the prior art, the shaping or crimping of the protective cover does not take place by roller burnishing or pressing, but substantially by press-fitting in the intermediate regions of the protective cover. In other words, the material of the protective cover is constricted in a targeted manner or locally in the intermediate regions and thus nestles against the non-circular external contour of the rotor body.

In a suitable development, the protective cover has a chamfer which is widened radially on the end face as an insertion aid for the rotor body. In other words, on the end face the protective cover has an oversized portion protruding into the air gap so that the rotor body can be inserted in the manner of a funnel. As a result, the insertion of the rotor body into the protective cover is simplified. The rotor body is introduced via the chamfer into the protective cover, wherein the chamfer is then bent inwardly or straightened radially by means of a first punch before the shaping of the flange collar. This means that the first punch radially inwardly bends the oversized portion of the protective cover protruding into the air gap. The bent chamfer forms, for example, the flange collar for the subsequent shaping or crimping step.

In an expedient embodiment, the flange collar after the shaping thereof is pressed by means of a second punch against the rotor body on the outer circumference thereof. This takes account of the fact that the material of the protective cover is pushed away by the shaping or by the crimping in the region of the curvatures. In other words, before the shaping process the curvatures substantially bear against the inner circumference of the protective cover, wherein due to the shaping the protective cover lifts away from the curvatures. This means that due to the deformation of the protective cover a clear (radial) spacing can be formed between the curvatures and the protective cover. The protective cover is thus deformed radially into the air gap in the region of the curvatures. This deformation in the region of the curvatures is remedied by the subsequent second punching process and the protective cover in the region of the curvatures is thus pushed or pressed again against the surface magnets. As a result, it is ensured that the protective cover does not bulk inadmissibly into the air gap.

The advantages and embodiments set forth regarding the rotor and/or the method are expediently also able to be transferred to the device described below and vice versa. The device according to the invention is provided and is suitable and designed for producing an above-described rotor. The device has a crown tool which is provided and designed to shape a flange collar of the protective cover into the radially indented regions between the curvatures of tangentially adjacent surface magnets of the rotor body in a positive and/or non-positive manner. The device also has, for example, a first and second punch. As a result, a particularly suitable device can be produced.

The crown tool of the device does not deform the protective cover tangentially over the circumference but merely at intervals or locally at the free spaces exposed by the curvatures between the rotor body and the protective cover.

In an expedient embodiment, the crown tool has a cylindrical tool body with a crown ring on the end face facing the rotor. The crown ring is configured to shape or deform the flange collar. A central projection which engages in a through-opening of the rotor body during the shaping process is also provided on the tool body. The through-opening of the rotor body serves for receiving a rotor shaft or motor shaft in the installed state. The bolt-shaped or cylindrical projection, for example, engages in a positive manner in the central through-opening so that the rotor body is positioned, stabilized and centered during the shaping process. The crown ring and the projection are formed integrally, i.e. in one piece or monolithically, on the tool body. The projection is designed, for example, as a pin or journal of the tool body. For the shaping, the crown tool is lowered from above in the manner of a punch on the end face onto the rotor body which is provided with the protective cover, wherein the projection engages in the through-opening and wherein the crown ring deforms, press-fits or crimps the flange collar in some regions.

In a conceivable embodiment, the crown ring has a number of axially protruding crown-shaped or castellation-shaped projections which are arranged so as to be tangentially distributed over the tool body circumference. Preferably, each castellation-shaped projection has a radially inwardly oriented shaping lug which shapes the flange collar during the shaping process. As a result, a particularly suitable tool and thus a particularly suitable device is produced for producing the rotor.

In a preferred application, the above-described rotor is part of an electric motor. The electric motor according to the invention is, for example, suitable and designed for a power steering system of a motor vehicle. The advantages and embodiments set forth regarding the rotor and/or the method and/or the device are also able to be transferred expediently to the electric motor and vice versa.

The electric motor has a stator and a motor shaft which is rotatably mounted relative thereto and on which the rotor is mounted fixedly to the shaft. The electric motor is configured, for example, as a brushless electric motor in the manner of an internal rotor.

In an application for a power steering system, the electric motor is arranged in the region of a driver's cab, wherein a particularly smooth motor operation is ensured by the rotor according to the invention since the surface magnets and the protective cover are held without vibrating on the rotor core. As a result, a generation of noise of the electric motor is reduced in an advantageous and simple manner, which is advantageously transferred to the user comfort of the motor vehicle.

Other features which are considered as characteristic for the invention are set forth in the appended claims.

Although the invention is illustrated and described herein as embodied in a rotor for an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded perspective view of a rotor in a partially exploded state;

FIG. 2 is an exploded, perspective view of the rotor;

FIG. 3 is a plan view of the rotor in a preassembled state;

FIG. 4 is a perspective view of a first punch for producing the rotor;

FIG. 5 is a perspective view of a rotor end face after a treatment by the first punch according to FIG. 4;

FIG. 6 is a perspective view of a crown tool for producing the rotor;

FIG. 7 is a perspective view of the rotor end face after a treatment with the crown tool according to FIG. 6;

FIG. 8 is a perspective view of a second punch for producing the rotor;

FIG. 9 is a perspective view of the rotor end face after a treatment with the second punch according to FIG. 8; and

FIG. 10 is a side view of the rotor.

### DETAILED DESCRIPTION OF THE INVENTION

Parts and sizes which correspond to one another are always provided in all of the figures with the same reference signs.

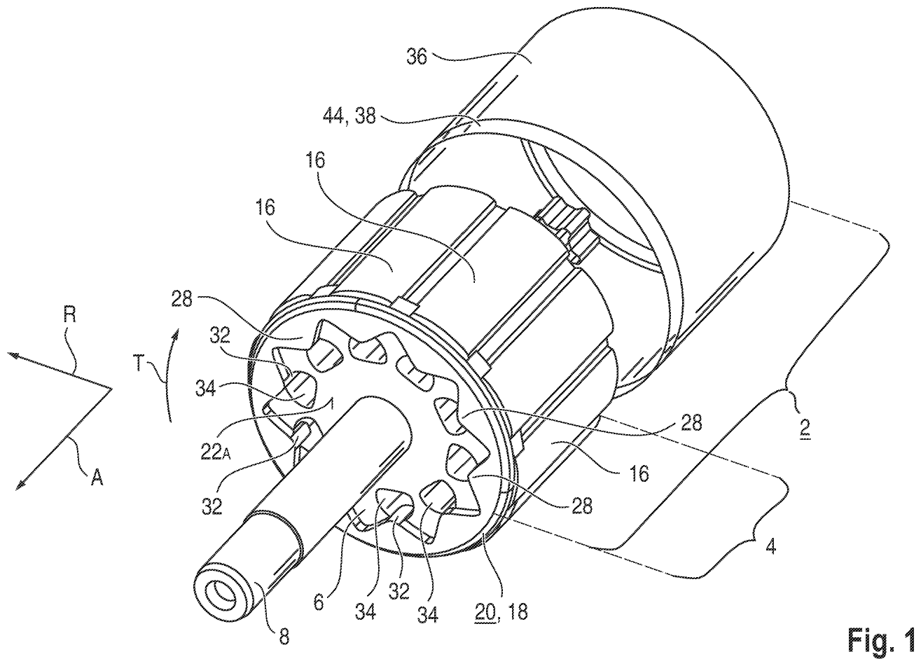

Referring now to the figures of the drawings in detail and first, particularly to FIG. 1 thereof, there is shown a rotor 2 of an electric motor, not shown in more detail. The electric motor which is configured as a brushless internal rotor is, for example, part of an electromotive power steering system of a motor vehicle. The rotor 2 has a rotor body 4 with an approximately cylindrical rotor core 6, which is joined to a motor shaft or rotor shaft 8 fixedly to the shaft. The motor shaft 8 and thus the rotor 2 in the assembled state are rotatably mounted relative to a stationary stator of the electric motor. In the assembled state, an annular air gap is formed between the outer circumference of the rotor 2 and the inner circumference of the stator.

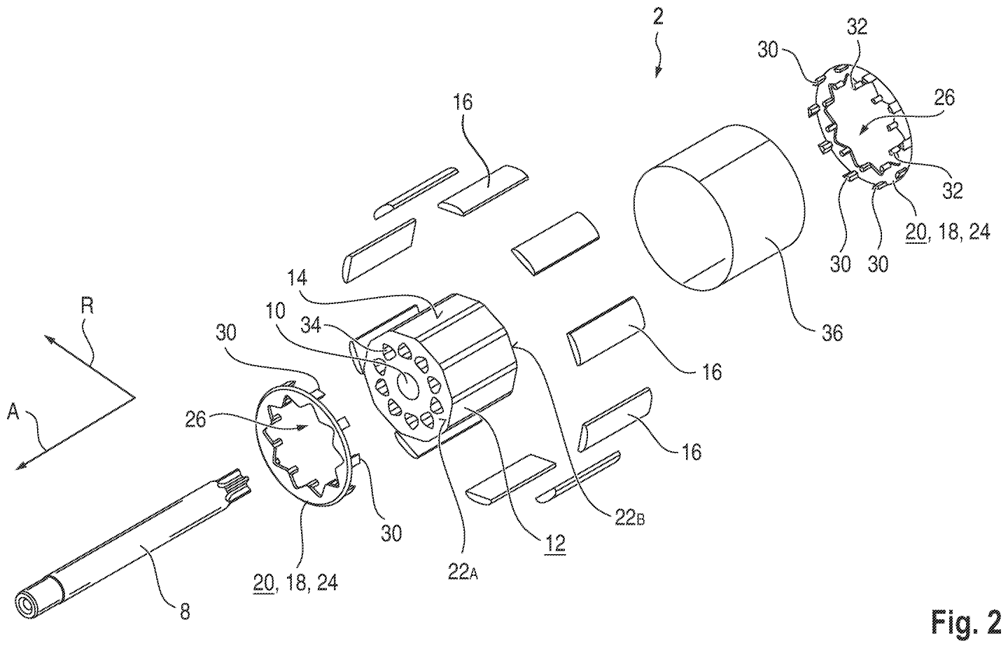

FIG. 2 shows the rotor 2 in an exploded state by way of an exploded view. As is relatively clearly visible in the exploded view of FIG. 2 the rotor core 6 in this exemplary embodiment has an equal-sided, ten-cornered bottom surface. The rotor core 6 is formed from a number of rotor laminations, not denoted in more detail, which are stacked and punch-packed in an axial direction A to form a lamination core (rotor lamination core). The rotor core 6 has a central through-opening 10 for receiving the motor shaft 8. The rotor core 6 also has a circumferential lateral surface 12 which extends in the axial direction A and which forms ten similar bearing surfaces 14 corresponding to the bottom surface. The bearing surfaces 14 are provided with reference signs merely by way of example in the figures.

The rotor 2 in this embodiment is configured as an SPM rotor with ten permanent magnetic surface magnets 16 for generating a magnetic excitation field. The surface magnets 16, which are provided with reference signs merely by way of example, are arranged in a tangential or azimuthal direction T on the rotor core 6 so as to be distributed on the outer circumference of the lateral surface 12. The surface magnets 16 are configured as bread loaf-shaped magnets and have in each case an approximately bread loaf-shaped cross-sectional shape in the axial direction A, wherein the surface magnets 16 are arranged so as to be positioned on a respectively assigned bearing surface 14 of the lateral surface 12. In the assembled state of the rotor 2, the surface magnets 16 are held and/or fastened by means of a holding device 18 on the lateral surface 12 of the rotor core 6 without a material connection.

The holding device 18 has two holding rings or insulation disks 20. As is relatively clearly visible with reference to FIG. 1 and FIG. 2, the holding rings 20 are positioned on opposing end faces 22a, 22b of the rotor core 6 in the joined or assembled state. The holding rings 20 have in each case a circular ring-shaped annular body 24. A central circular ring opening 26 is incorporated in the annular body 24 for passing through the motor shaft 8. The radially internal circumference of the annular body 24, i.e. the inner wall of the circular ring opening 26, in a radial direction R has an approximately star-shaped cross-sectional shape or internal contour in the exemplary embodiments shown. The star-shaped cross-sectional shape of the inner wall is formed by ten radially inwardly protruding toothed projections 28 of the annular body 24. The toothed projections 28 are provided with reference signs merely by way of example in the figures.

On a lower face facing the rotor core 6, the annular bodies 24 have in each case ten holding contours 30 on the outer circumference and ten fastening projections 32 on the inner circumference. The holding contours 30 and the fastening projections 32 are integrally formed so as to protrude axially from the lower face of the annular body 24. The holding contours 30 are arranged so as to be distributed uniformly along the outer circumference of the annular body 24. The fastening projections 32 are arranged so as to be distributed along the inner circumference, wherein the fastening projections 32, in particular, are integrally formed, i.e. in one piece or monolithically, in the region of one respective radially internal tooth end of the tooth projections 28.

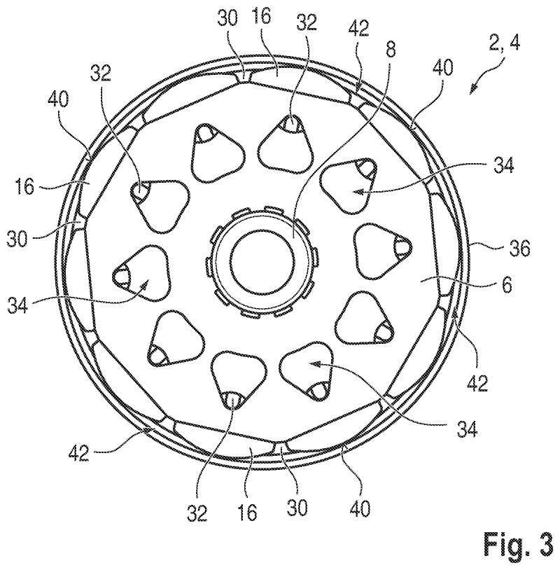

As can be identified, for example, in the view of FIG. 3, the distribution spacing of the holding contours 30 and the fastening projections 32 to one another is arranged such that in each case a fastening projection 30 is arranged between two adjacent holding contours 32 in the tangential direction T.

For reducing the moment of inertia of the rotor 2, the rotor core 6 is provided with ten recesses 34 penetrating the lamination core. The recesses 34 are arranged so as to be distributed uniformly around the central through-opening 10 in the tangential direction T. The recesses 34 are provided with reference signs merely by way of example in the figures.

As is visible in particular in FIG. 3, the recesses 34 have in the axial direction A an approximately teardrop-shaped cross-sectional shape. In the assembled state, the fastening projections 32 of the annular body 24 engage in the recesses 34. The teardrop shape of the recesses 34 acts in the manner of a centering aid when the holding rings 20 are joined to the rotor core 6. This means that the holding ring 20 axially engages in the rotor core 6 at least in some portions by means of the fastening projections 32.

The holding contours 30, which are arranged radially externally in the radial direction R, have an approximately trapezoidal cross-sectional shape in the axial direction. The bottom sides of the cross-sectional shape are oriented in the tangential direction T. The radially internal bottom side has a shorter dimension in comparison with the radially external bottom side. The leg sides running between the bottom sides run obliquely to the tangential direction T and obliquely to the radial direction R.

As is visible in particular in FIG. 3, the distribution spacing of the holding contours 30 is arranged such that the holding contours 30 are arranged in the corner regions of the ten-cornered rotor core 6. In other words, the holding contours 30 are arranged in the corner regions between two adjacent bearing surfaces 14. The recesses 34 are oriented in the radial direction R approximately centrally to the respective bearing surfaces 12.

As is visible relatively clearly in the plan view of FIG. 3, an approximately three-point-type fastening is implemented by means of the holding ring 20 for each surface magnet 16. Here the leg sides of the holding contours 30 bear against the radially external contour of the surface magnets 16, such that the surface magnets 16 are tangentially and radially gripped at least in some portions in these bearing regions. This means that the surface magnets 16 are held in a positive manner by means of the holding contours 30 in the tangential direction T and radial direction R, wherein by the engagement of the fastening projections 32 in the recesses 34, an anti-slip device or anti-slip protection of the surface magnets 16 is implemented on the lateral surface 12. The surface magnets 16 are covered on the end faces 22a, 22b of the rotor core 6 in the radial direction R at least in some portions by the annular bodies 24 of the holding rings 20. Thus the surface magnets 16 are gripped in a positive manner in the axial direction A between the holding rings 20.

For protecting the surface magnets 16 against slipping, a sleeve-like protective cover 36 is positioned on the outer circumference of the rotor body 4. The protective cover 36 is preferably produced from a steel, in particular a stainless steel. In other words, the protective cover 36 is, in particular, a stainless steel cover.

A method for producing the rotor 2, in particular for fastening the protective cover 36 to the rotor body 4, by means of a device not shown in more detail is explained in more detail hereinafter by way of FIGS. 3 to 10.

In a first method step, the rotor body 4 is inserted into the protective cover 36. The protective cover 36 on the end face facing the rotor body 4, for example, has a chamfer 38 (FIG. 1) which is radially widened as an insertion aid. The chamfer 38 has a radial oversized portion protruding into the air gap so that the rotor body 4 can be inserted or introduced into the protective cover 36 in the manner of a funnel.

As is visible in particular in FIG. 3, the surface magnets 16 have a convex curvature 40 toward the outer circumference. The curvatures 40 of the surface magnets 16 radially project over the outer circumference of the annular body 24. In other words, the curvatures 40 of the surface magnets 16 form the radially outermost points of the rotor body 4. Due to the curvatures 40 of the surface magnets 16, the outer circumference of the rotor body 4 thus has no circular (outer) shape or (outer) contour. The protective cover 36 has a substantially circular cross-sectional shape which bears against the crests of the curvatures 40 on the internal circumference. As a result, between the protective cover 36 and the flanks of respectively two tangentially adjacent surface magnets 16, ten regions 42 or free spaces distributed over the circumference as clear spacings are configured between the outer circumference of the rotor body 4 and the inner circumference of the protective cover 36.

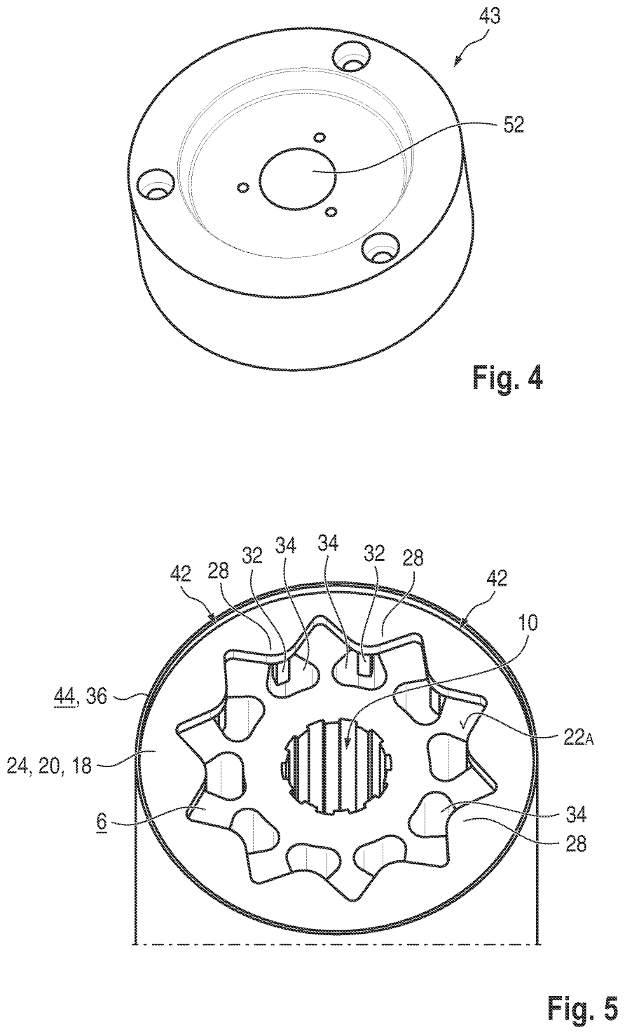

After the insertion of the rotor core 4 into the protective cover 36, the chamfer 38 is bent or straightened radially inwardly by means of a (first) punch 43 shown in FIG. 4. This means that the punch 43 radially inwardly bends the oversized portion of the protective cover 36 protruding into the air gap. To this end, the approximately cylindrical punch 43 on the end face has a circular recess with side walls inclined in the manner of a chamfer. When the punch 43 is lowered, the chamfer 38 of the protective cover 36 is pressed by the inclined side walls against the outer circumference of the rotor core 4.

In the next method step, a flange collar 44 (crimped edge) is shaped on the end face of the protective cover 36. The flange collar 44 is an axial portion of the protective cover 36 on the end face which, for example, encompasses therewith the straightened chamfer 38. The flange collar 44, which has not been shaped, protrudes at least partially axially over the inserted rotor body 4. In the views of FIGS. 5, 7 and 9, the flange collar 44 (which has not been shaped) has, for example, an axial projection of less than 15 mm (millimeters), in particular less than 10 mm, for example approximately 5 mm.

After the rotor body 4 has been inserted into the protective cover 36, the flange collar 44 is shaped, press-fitted or crimped into the radially indented regions 42 between the curvatures 40 in a positive and/or non-positive manner. This means that the assembly forces for joining the protective cover 36 to the rotor body 4 are introduced into the intermediate regions in a targeted manner. In other words, the free spaces or free surfaces formed between the flanks of the curvatures 40 are used as points of attack for a shaping tool. This means that the surface of the protective cover 36 in the regions 42 is radially inwardly deformed or crimped radially inwardly as local press-fitted surfaces.

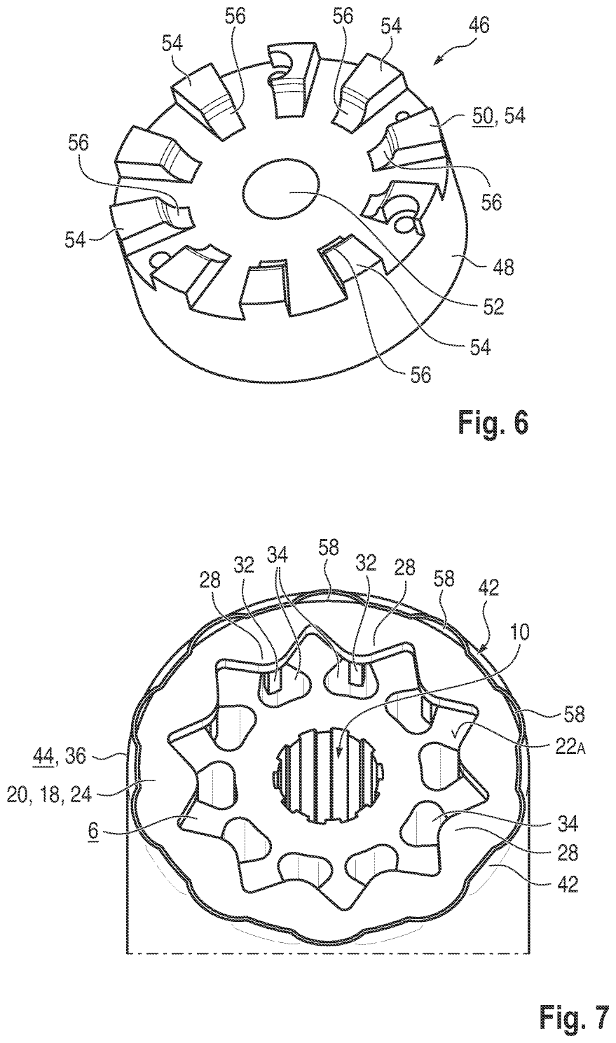

For shaping the flange collar 44, the device has a crown tool 46 as a shaping punch. The crown tool 46 of the device, shown separately in FIG. 6, has a cylindrical tool body 48 with a crown ring 50 facing the rotor 2 on the end face and a central recess 52 for a projection, not shown in more detail.

The bolt-shaped or cylindrical projection is inserted, for example, as a pin or journal into the recess 52. Alternatively, the projection can also be integrally formed in one piece on the tool body 48. The diameter of the projection is slightly smaller than the internal diameter of the through-opening 10.

The crown ring 50 has ten crown projections or castellation-shaped projections 54 which are arranged so as to be distributed over the circumference. The castellation-shaped projections 54 have in each case a radially inwardly oriented shaping lug 56. The shaping lug 56 has an axially inclined ramp as a shaping contour for the flange collar 44.

For the shaping, the crown tool 46 is lowered in the manner of a punch in the direction of the end face 22a from above the rotor body 4 provided with the protective cover 36. The projection engages in the through-opening 10 so that the rotor body 4 and the crown tool 46 are centered and oriented so as to be axially aligned with one another. When the crown tool 46 is lowered, the flange collar 44 is shaped, press-fitted or crimped by means of the shaping lugs 56 into the regions 42.

The upper edge of the flange collar 44 is crimped radially inwardly into the regions 42 by the crown tool 46, so that the holding ring 20—and thus the rotor body 4—in the regions 42 is axially encompassed at least in some portions by the flange collar 44.

FIG. 7 shows a view of the end face of the rotor 2 after the shaping by the crown tool 46. As is relatively clearly visible in FIG. 6, the material of the protective cover 36 is pushed away or lifted away by the shaping in the region of the curvatures 40. In other words, by the shaping in the regions 42, a clear spacing 58 is formed in the region of the curvatures 40 located therebetween. As a result, the protective cover 36 in the region of the curvatures 40 or in the region of the spacings 58 is radially deformed in the subsequent air gap between the rotor 2 and stator.

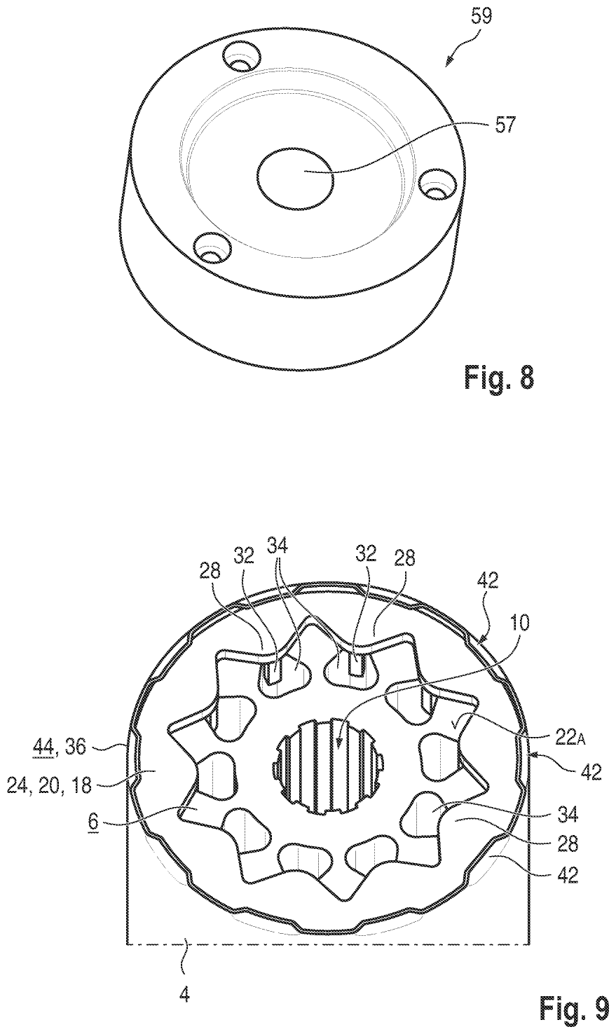

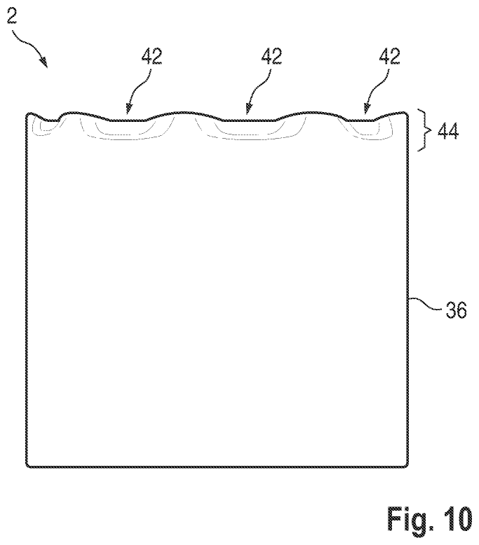

For reducing the spacings 58, in a third method step the flange collar 44 is thus axially and radially pressed against the rotor body 4 or the holding ring 20 by means of a (second) punch 59 shown in FIG. 8. The punch 59 is designed in a similar manner to the punch 43, wherein the central recess of the punch 59 is designed to be deeper than that of the punch 43. For example, the diameter of the recess is larger in the punch 43 than in the punch 59. The punches 43 and 59 also have, for example, recesses 52 for a projection engaging into the through-opening 10 when lowered. FIGS. 9 and 10 show the rotor 2 in the joined state after the third method step.

By the (second) punch 43 the material of the protective cover 36 in the region of the flange collar 44 is pressed from outside onto the rotor body 4 so that the spacings 58 are substantially shaped to zero. In other words, the protective cover 36 or the flange collar 44 nestles against the curvatures 40 on the outer circumferential side. The protective cover 36 thus encompasses in the region of the flange collar 44 the outer contour of the rotor body 4 in a radially and tangentially positive manner.

According to the method, therefore, the space between the surface magnets 16 is used for the targeted introduction of the assembly forces. Since the holding ring 20 is radially slightly smaller than the outer circumference of the rotor body 4, and at this point no surface magnet 16 is located in the axial direction, the material of the protective cover 36 is forced both radially and axially into the free regions 42 during the shaping by the crown tool 46, which leads to a smaller bulk of the material in the radial direction. In particular, the material is forced axially downwardly, i.e. in the direction of the end face 22b, into the free region, whereby a radial bulk of the material is reduced. The bulky material in these regions 42 does not negatively affect the electric motor or the air gap, since the spacing toward the stator in these regions 42 is substantially greater than in the region of the curvatures 40. According to the method, a targeted radial bulking of the protective cover 36 is brought about or taken into consideration merely in the regions 42 at which the radial spacing to the stator is greater.

The claimed invention is not limited to the above-described embodiments. Rather, other variants of the invention can be derived therefrom by a person skilled in the art within the context of the disclosed claims, without departing from the subject of the claimed invention. In particular, all of the individual features described in connection with the various exemplary embodiments can be combined together in different ways within the scope of the disclosed claims, without departing from the subject of the claimed invention.

Thus the crown tool 46, for example, is also inventive per se and thus represents an invention in its own right.

The following is a summary list of reference numerals and the corresponding structure used in the above description of the invention.

### LIST OF REFERENCE SIGNS

2 Rotor
4 Rotor body
6 Rotor core
8 Motor shaft
10 Through-opening
12 Lateral surface
14 Bearing surface
16 Surface magnet
18 Holding device
20 Holding ring
22a, 22b End face
24 Annular body
26 Circular ring opening
28 Toothed projection
Holding contour
32 Fastening projection
34 Recess
36 Protective cover
38 Chamfer
40 Curvature
42 Region
43 Punch
44 Flange collar
46 Crown tool
48 Tool body
50 Crown ring
52 Recess
54 Castellation-shaped projection
56 Shaping lug
58 Spacing
59 Punch
A Axial direction
R Radial direction
T Tangential direction

1. A rotor for an electric motor, the rotor comprising:
a rotor body having a cylindrical rotor core and a plurality of surface magnets disposed so as to be distributed on a lateral surface of said cylindrical rotor core in a form of rotor poles and which have a bread loaf-shaped cross-sectional shape with a convex curvature oriented toward an outer circumference; and
a sleeve-shaped protective cover positioned on said outer circumference of said rotor body, said sleeve-shaped protective cover having a flange collar at least on an end face, said flange collar being shaped as to have radially indented regions formed between tangentially adjacent said surface magnets resulting in a form-locking and/or a force-locking connection between said radially indented regions and said surface magnets.

2. The rotor according to claim 1, wherein said rotor body has a holding device positioned on said cylindrical rotor core on said end face for fastening and/or holding said surface magnets on said lateral surface of said cylindrical rotor core without a material connection, wherein said convex curvatures of said surface magnets radially protrude over an outer circumference of said holding device.

3. A method for producing a rotor, which comprises the steps of:
providing a rotor body having a cylindrical rotor core and a plurality of surface magnets disposed so as to be distributed on a lateral surface of said cylindrical rotor core in a form of rotor poles and which have a bread loaf-shaped cross-sectional shape with a convex curvature oriented toward an outer circumference;
providing a sleeve-shaped protective cover for receiving the rotor body;
inserting the rotor body into the sleeve-shaped protective cover; and
shaping a flange collar on an end face of the sleeve-shaped protective cover, by means of a crown tool, into radially indented regions between convex curvatures of tangentially adjacent said surface magnets resulting in a form-locking and/or a force-locking connection between the radially indented regions and the surface magnets.

4. The method according to claim 3, wherein the sleeve-shaped protective cover has a chamfer which is radially widened on an end face as an insertion aid for the rotor body, wherein the rotor body is introduced via the chamfer into the sleeve-shaped protective cover and wherein the chamfer is bent radially inwardly by means of a first punch before the shaping of the flange collar.

5. The method according to claim 3, wherein after performing the shaping of the flange collar, pressing the flange collar by means of a second punch against the rotor body on the outer circumference thereof.

6. A device for producing a rotor, the rotor containing a rotor body having a cylindrical rotor core and a plurality of surface magnets disposed so as to be distributed on a lateral surface of the cylindrical rotor core in a form of rotor poles and which have a bread loaf-shaped cross-sectional shape with a convex curvature oriented toward an outer circumference, the rotor further having a sleeve-shaped protective cover positioned on the outer circumference of the rotor body, the sleeve-shaped protective cover having a flange collar at least on an end face, the flange collar being shaped as to have radially indented regions formed between tangentially adjacent said surface magnets resulting in a form-locking and/or a force-locking connection between the radially indented regions and the surface magnets, the device comprising:
a crown tool configured to shape the flange collar of the sleeve-shaped protective cover into the radially indented regions between the curvatures of tangentially adjacent said surface magnets of the rotor body resulting in a form-locking and/or a force-locking connection between the radially indented regions and the surface magnets.

7. The device according to claim 6, wherein said crown tool has a cylindrical tool body with a crown ring on an end face for shaping the flange collar and further has a cylindrical projection, wherein said cylindrical projection engages in a through-opening of the rotor body during a shaping of the flange collar.

8. The device according to claim 7, wherein said crown ring has a plurality of axially protruding castellation-shaped projections which are disposed so as to be tangentially distributed over a tool body circumference.

9. The device according to claim 8, wherein each of said protruding castellation-shaped projections has a radially inwardly oriented shaping lug.

10. An electric motor for a motor vehicle, the electric motor comprising:
a rotor, containing:
a rotor body having a cylindrical rotor core and a plurality of surface magnets disposed so as to be distributed on a lateral surface of said cylindrical rotor core in a form of rotor poles and which have a bread loaf-shaped cross-sectional shape with a convex curvature oriented toward an outer circumference; and
a sleeve-shaped protective cover positioned on said outer circumference of said rotor body, said sleeve-shaped protective cover having a flange collar at least on an end face, said flange collar being shaped as to have radially indented regions formed between said tangentially adjacent surface magnets resulting in a form-locking and/or a force-locking connection between said radially indented regions and said surface magnets.
